(19) United States
(12) Patent Application Publication
(10) Pub. No.: US 2004/0112226 A1
(43) Pub. Date: Jun. 17, 2004

(54) Charcoal tray and grate lift system for gas barbecue grills

(76) Inventors: Robert Johnston, Columbus, GA (US); Alex T. Gafford, Midland, GA (US); Dan Mitchell, Columbus, GA (US); Sam Zaidspiner, Lawrenceville, GA (US); Joseph Hale Andrews, Fortson, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/703,966

(22) Filed: Nov. 7, 2003

Related U.S. Application Data
(60) Provisional application No. 60/425,102, filed on Nov. 8, 2002.

(51) Int. Cl. A23L 1/00

(52) U.S. Cl. 99/339; 99/340; 99/450

(57) ABSTRACT

A gas barbecue grill including a firebox assembly containing a gas burner element, a cooking grate supported thereabove, a top casting rotatably affixed thereto, the firebox assembly defining a receiving slot in a sidewall thereof, and a tray carrier assembly configured to be slidably received within the receiving slot of the firebox assembly, the tray carrier assembly being configured to support a charcoal tray. The gas barbecue grill further includes a grate frame configured to support the cooking grate, and a grate lift assembly configured to raise and lower the grate frame relative to the firebox assembly.

### CROSS-REFERENCE TO RELATED APPLICATION

This application claims priority to copending U.S. provisional application entitled, “CHARCOAL TRAY SYSTEM FOR GAS BARBECUE GRILL” having Serial No. 60/425,102, filed Nov. 8, 2002, which is entirely incorporated herein by reference.

### TECHNICAL FIELD

The present invention relates generally to barbecue grills, and, more particularly, to a charcoal tray and grate lift system for use in a gas barbecue grill.

### BACKGROUND OF THE INVENTION

Outdoor cooking has experienced tremendous growth. This is due in large part to the fact that barbecue grills, both charcoal and gas, have become much easier to use and more efficient at cooking a wide range of food items. Although both charcoal and gas barbecue grills have seen improvements in recent years, the advantages of gas barbecue grills have been well recognized. Gas barbecue grills can quickly bring a heated surface to a desired temperature and may provide a high rate of heat exchange. Therefore, gas barbecue grills generally require less time to prepare food items than the charcoal grills. Gas barbecue grills allow for finer control of cooking temperatures than do charcoal barbecue grills. Even with these noted advantages, there are still those individuals who would prefer to cook using a charcoal barbecue grill.

Charcoal barbecue grills offer a number of advantages as well. For example, charcoal barbecue grills tend to be of simple construction, and therefore, tend to cost less than gas barbecue grills. Charcoal barbecue grills do not require an external fuel source, such as, a liquid propane tank. Although means do exist for determining the amount of propane in a tank, it is not uncommon to run out of fuel while preparing food items on a gas grill. Many individuals also prefer the flavor imparted to food items by cooking with charcoal briquettes. Similarly, charcoal barbecue grills allow individuals to easily use such items as wood chips to further flavor the food items they are preparing by simply adding the wood chips to the pile of briquettes. Gas barbecue grills tend to cost more to operate than charcoal barbecue grills because the fuel source must be continually resupplied and items such as replacement burner elements must be purchased periodically to maintain proper operation of the gas barbecue grill.

The Krall patent, U.S. Pat. No. 6,173,644, issued Jan. 16, 2001, discloses an apparatus for converting a gas grill into a charcoal burning grill for using charcoal or other flammable material in a gas grill. The adapter includes an adapter container for holding flammable material and the adapter container is removably positionable in the interior of the housing. To install the adapter, the screen, i.e. cooking grate, is removed from the grill, and the adapter container is positioned in the interior of the housing. Once the adapter container is positioned within the housing, the screen is replaced such that the screen covers the adapter container.

The use of the Krall adapter is somewhat limiting, requiring that the decision to use the charcoal be made in advance of heating the grill, and requiring use of either gas or charcoal over the entire cook surface. Thus, while providing a useful variation in the possible modes of cooking, improvements can be envisioned to enhance the concept.

Therefore, a need exists to address these and other deficiencies and to provide an improved apparatus allowing barbecue grills to function in both the gas and charcoal modes.

### SUMMARY OF THE INVENTION

An embodiment, among others, of the disclosed gas barbecue grill includes a firebox assembly containing a gas burner element, a cooking grate supported thereabove, a top casting rotatably affixed thereto, wherein the firebox assembly defines a receiving slot in a sidewall thereof. A tray carrier assembly is configured to be slidably received within the receiving slot of the firebox assembly, the tray carrier assembly being configured to support a charcoal tray.

A preferred embodiment, among others, of a barbecue grill, as disclosed herein, includes a charcoal grate lift system for gas barbecue grills. The barbecue grill includes a firebox assembly, a cooking grate supported above the firebox assembly, a top casting rotatably affixed to the firebox assembly, and a grate lift assembly configured to raise and lower the cooking grate relative to the firebox. The grate lift assembly includes a support frame adjacent the cooking grate for supporting the cooking grate, a first pivot wire having a first end and a second end, the first end being rotatably mounted to the firebox assembly and the second end being rotatably mounted to the support frame. A lift wire has a proximal end rotatably mounted to the support frame, a central portion, and a distal end, the lift wire being pivotally mounted to the firebox assembly such that urging the distal end downwardly causes the lift wire to pivot about the central portion, thereby causing the grate assembly to be raised relative to the firebox assembly.

A preferred embodiment, among others, of a barbecue grill, as disclosed herein, includes a firebox assembly, a cooking grate supported above the firebox assembly, a top casting rotatably affixed to the firebox assembly, and a grate lift assembly configured to raise and lower the cooking grate relative to the firebox. The grate lift assembly includes a grate frame configured to support the cooking grate, a cam including a cam track, the cam being rotatably secured to the gas barbecue grill, and a lift roller rotatably secured to the grate frame, the lift roller being configured to cooperate with the cam track. Rotation of the cam causes the lift roller to move along the cam track, thereby causing the grate frame to move relative to the firebox.

A preferred embodiment, among others, of a barbecue grill, as disclosed herein, includes a firebox assembly, a cooking grate supported above the firebox assembly, a top casting rotatably affixed to the firebox assembly, and a grate lift assembly configured to raise and lower the cooking grate relative to the firebox. The grate lift assembly includes a grate frame configured to support the cooking grate, and a jack coupled to the grate frame, the jack being configured to raise and lower the grate frame relative to the firebox assembly.

Other features and advantages of the present invention will become apparent to one with skill in the art upon examination of the following drawings and detailed description. It is intended that all such features and advantages be included herein within the scope of the present invention, as defined in the appended claims.

### BRIEF DESCRIPTION OF THE DRAWINGS

The present invention, as defined in the claims, can be better understood with reference to the following drawings. The components in the drawings are not necessarily to scale relative to each other, emphasis instead being placed upon clearly illustrating the principles of the present invention.

FIG. 1 is an exploded perspective view of a preferred embodiment of a gas barbecue grill including an exemplary charcoal tray and grate lift system according to an embodiment of the present invention.

FIG. 2 is a partial perspective view of the preferred embodiment of a gas barbecue grill illustrated in FIG. 1.

FIG. 3 is a partial perspective, cut-away view of the embodiment of the grate lift system of the gas barbecue grill as shown in FIG. 1, with the cooking grate and grate frame in a raised position.

FIGS. 4A-4C are partial front views of the embodiment of the grate lift system as shown in FIG. 3, with the cooking grate and cooking frame in the raised, middle, and lowered positions, respectively.

FIG. 5 is an isolated, perspective view of a preferred embodiment of an exemplary grate lift system according to an embodiment of the present invention, with the cooking grate and grate frame in a lowered position.

FIG. 6 is a partial perspective, cut-away view of the embodiment of the grate lift system as shown in FIG. 5, with the cooking grate and grate frame in a raised position.

FIG. 7 is an isolated, perspective view of a preferred embodiment of an exemplary grate lift system according to an embodiment of the present invention.

FIG. 8 is a partial perspective view of a preferred embodiment of a barbecue grill including the grate lift system as shown in FIG. 7.

FIGS. 9A and 9B are partial perspective, cut-away views of the preferred embodiment of a gas barbecue grill illustrated in FIG. 8, with the cooking grate in a lowered position and a raised position, respectively.

### DETAILED DESCRIPTION OF PREFERRED EMBODIMENTS

In the following detailed description, reference is made to the accompanying drawings which form a part hereof, and in which are shown by way of illustration specific embodiments of a removable charcoal tray and grate lift system for use in a gas barbecue grill. It is to be understood that other embodiments may be utilized and structural changes may be made. The following detailed description, therefore, is not to be taken in a limiting sense.

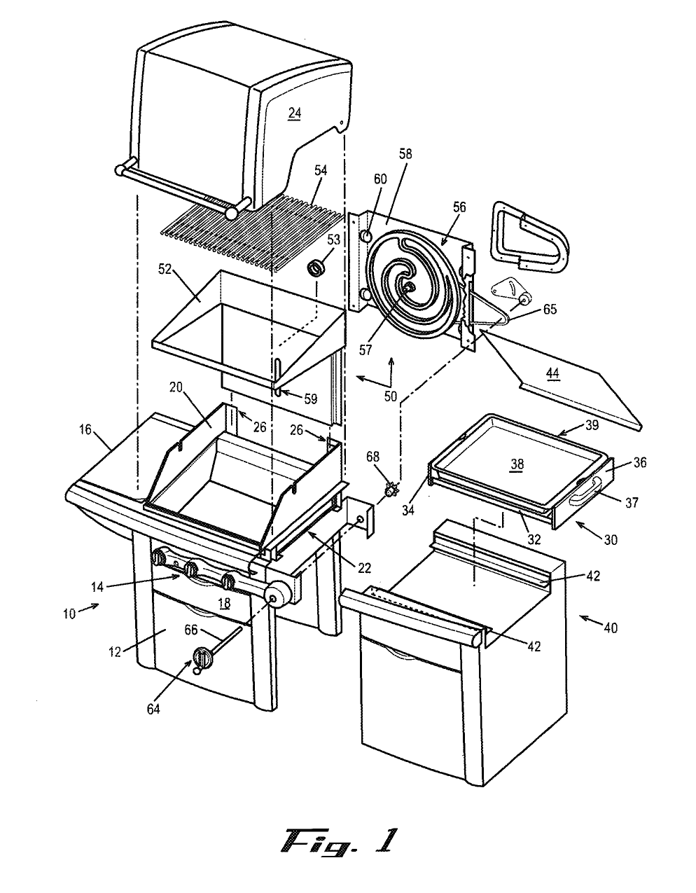

Referring now to the figures, wherein like reference numerals indicate corresponding components throughout the several views, one example of a charcoal tray and grate lift system constructed in accordance with the present invention is illustrated in FIG. 1. A preferred embodiment includes a barbecue grill 10 including a firebox assembly 20, and a grate lift assembly 50, including a grate frame 52 within the interior of the firebox assembly 20. Removably disposed on the grate frame 52 is a cooking grate 54 for use in cooking food items.

Contained within the interior firebox assembly 20 are one or more gas burner(s) or gas burner element(s) (not shown and collectively referred to hereinafter as “gas burners”) that may be configured in various manners as would be known to one of ordinary skill in the art. As depicted in the preferred embodiment illustrated in FIG. 1, the firebox assembly 20 is configured with a substantially rectangular receiving slot 22 disposed through a first side of the firebox assembly 20. The preferred receiving slot 22 is configured substantially horizontally, with the longer top and bottom edges running substantially the width of the firebox assembly 20. The receiving slot 22 may be of various shapes and sizes, and is shaped and dimensioned so as to receive the tray carrier assembly 30 described below.

In the preferred embodiment, connected to the first side of the firebox assembly 20, below the receiving slot 22, is a charcoal tray housing assembly 40. The charcoal tray housing assembly 40 may be permanently affixed to the firebox assembly 20 in a variety of ways, including welding, with bolts or other fastening devices, or by other methods of attachment. In other embodiments, the firebox assembly 20 and the charcoal tray housing assembly 40 may both be one continuous assembly.

In yet other embodiments, the charcoal tray housing assembly 40 may be removably attached to the firebox assembly 20, by any of a variety of mechanisms or devices, allowing the charcoal tray housing assembly 40 to be attached to the firebox assembly 20 when desired for use, and then removed from the firebox assembly 20 when desired, e.g., such as for storage or transportation of the charcoal tray assembly 20 and/or the barbecue grill 10.

In this preferred embodiment, the charcoal tray housing assembly 40 attached to the firebox assembly 20 is positioned such that it does not obstruct the opening of receiving slot 22 and does not prevent the tray carrier assembly 30 from engaging the receiving slot 22, as described below.

Additionally, the preferred charcoal tray housing assembly 40 depicted in FIG. 1 may include one or more ledge portions 42 disposed on the interior of the side walls of the charcoal tray housing assembly 40. In the preferred embodiment, there will be one ledge portion 42 affixed to each interior longitudinal side wall of the charcoal tray housing assembly 40, and each preferred ledge portion 42 will run substantially the length of the respective longitudinal side wall.

Further, in the preferred embodiment, a tray carrier assembly 30 will be movably or slidably engaged within the charcoal tray housing assembly 40. The preferred tray carrier assembly 30 will include two carrier members 32 connected with a back plate portion 34 and a front plate portion 36 to form a substantially rectangular frame. Optionally, a handle 37 may be affixed to the front plate portion 36. Additionally, the preferred tray carrier assembly 30 is configured to receive the charcoal tray 38 containing the charcoal to be heated in the barbecue grill 10.

In the preferred embodiment depicted in FIG. 1, the preferred charcoal tray 38 is a shallow, substantially rectangular pan configured with a lip portion 39 extending outwardly from the top edges of the charcoal tray 38. In this embodiment, the lip portion 39 of the charcoal tray 38 engages the top edge of the carrier members 32 of the tray carrier assembly 30 when the charcoal tray 38 is placed in the tray carrier assembly 30. As indicated, the preferred charcoal tray 38 will be a substantially rectangular pan; however, the charcoal tray 38 may be oval, polygonal, substantially triangular, or other appropriate shape, and may vary in depth as desired.

The preferred tray carrier assembly 30 may be removably disposed within the preferred charcoal tray housing assembly 40, with each carrier member 32 of the tray carrier assembly 30 engaging one of the ledge portions 42 of the charcoal tray housing assembly 40, such that the tray carrier assembly 30 is movably or slidably engaged with the charcoal tray housing assembly 40. In this manner, the tray carrier assembly 30 is allowed to move or slide along the ledge portions 42, parallel to the longitudinal walls of the charcoal tray housing assembly 40 as desired.

Note that other mechanisms or methods may be used to engage the tray carrier assembly 30 with the charcoal tray housing assembly 40 such that the tray carrier assembly 30 may be moved parallel to the longitudinal walls of the charcoal tray housing assembly 40, including rollers, glides, channels for receiving the tray carrier assembly 40, etc., as would be known to one of ordinary skill in the art, and all such mechanisms or methods are intended to be included within the disclosure and the invention.

Additionally, the preferred charcoal tray housing assembly 40 will preferably include an access cover 44 hingedly connected to the charcoal tray housing assembly 40, allowing the access cover 44 to cover, hide, and/or protect the charcoal tray 38 and tray carrier assembly 30 when the access cover 44 is placed in a closed position. In the closed position, the access cover 44 serves as a convenient side shelf for use by the chef. Conversely, when the access cover 44 is placed in an open position, the charcoal tray 38 and tray carrier assembly 30 are exposed.

When the tray carrier assembly 30 is movably or slidably engaged with the charcoal tray housing assembly 40 in the preferred embodiment, the barbecue grill 10 may be used as a gas grill, heating food items on the cooking grate 54 with the gas burners in the interior of the firebox assembly 20. When the barbecue grill 10 is operated in this manner, the charcoal tray 38 containing the charcoal (or empty if desired) is contained within the charcoal tray housing assembly 40 (i.e. outside the firebox assembly 20). Further, in a preferred embodiment, the back plate portion 34 of the tray carrier assembly 30 will be configured and dimensioned to substantially fill the receiving slot 22, so as to prevent heat and/or flames from leaving the firebox assembly 20 through the receiving slot 22.

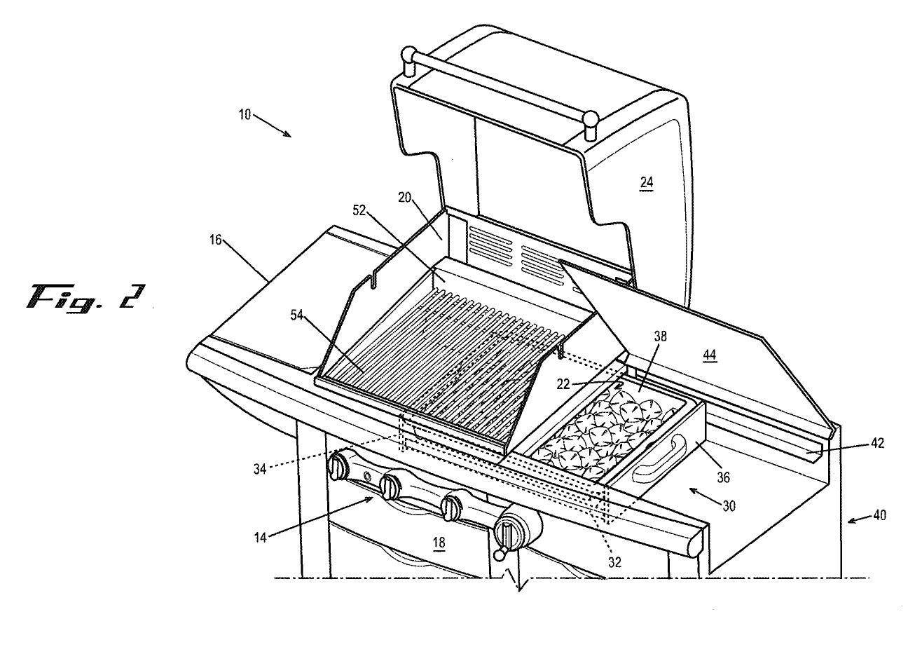

As shown in FIG. 2, when a user desires to use the barbecue grill 10 to cook food items with charcoal, the user slides or moves the tray carrier assembly 30 containing the charcoal tray 38 into the firebox assembly 20 through the receiving slot 22, without the need to remove the cooking grate 54.

In the preferred embodiment, the tray carrier assembly 30 can be moved by the user manipulating the handle 37 attached to the front plate portion 36 of the tray carrier assembly 30, allowing easy full or partial insertion or removal of the charcoal tray 38 at any stage of grilling, without the need to handle or manipulate the cooking grate 54. To that end, the preferred handle 37 may be composed of, coated in, or otherwise contain or have a non-conductive surface so as to allow manipulation of the handle 37 when the charcoal tray 38 and/or tray carrier assembly 30 is hot.

Additionally, to prevent the tray carrier assembly 30 with the charcoal tray 38 from contacting, or resting on the gas burners when the tray carrier assembly 30 is inserted into the firebox assembly 20, the interior of the firebox assembly 20 may be configured with ledges, slots, channels, a screen, etc. to engage the tray carrier assembly 30, while still allowing the gas burners to heat the charcoal in the charcoal tray 38.

The user has the option of inserting the tray carrier assembly 30 with the charcoal tray 38 into the firebox assembly 20 through the receiving slot 22 in order to use charcoal to cook food items over the entire cooking grate 54. The charcoal is heated and/or ignited by the gas burners, upon which the gas burners can be turned off and cooking accomplished solely with the hot charcoals. In this configuration, the front portion 36 of the tray carrier assembly 30 will preferably be configured and dimensioned larger than the receiving slot 22 to act as a stop against the firebox assembly 20 to limit the travel of the tray carrier assembly 30 into the firebox assembly 20.

Additionally, as desired, the tray carrier assembly 30 with the charcoal tray 38 may be partially inserted (FIG. 2) into the firebox assembly 20 through the receiving slot 22, allowing food to be cooked on a portion of the cooking grate 54 by the charcoal, while at the same time, food items may be cooked directly by the gas burners on the other portion of the cooking grate 54, in any desired proportion (i.e. half charcoal and half gas; one third charcoal and two thirds gas; one quarter gas and three quarters charcoal; or any proportion desired). Detents or stops may be employed to achieve various configurations.

Preferably, the barbecue grill 10 will also optionally include various other features in different embodiments and implementations, such as wheels (not shown), a side burner 16, drawers 18 or other storage areas in the base, etc., as would be known to one of ordinary skill in the art.

Note that in the preferred embodiment described above, the charcoal tray 38 containing the charcoal, when placed into the firebox assembly 20 through the receiving slot 22, may be located in relatively close proximity to the cooking grate 54. For some food items it may be desirable to have the cooking grate 54 further away from the charcoal (or from the gas burners) when cooking the food items, for warming or slow cooking purposes, etc.

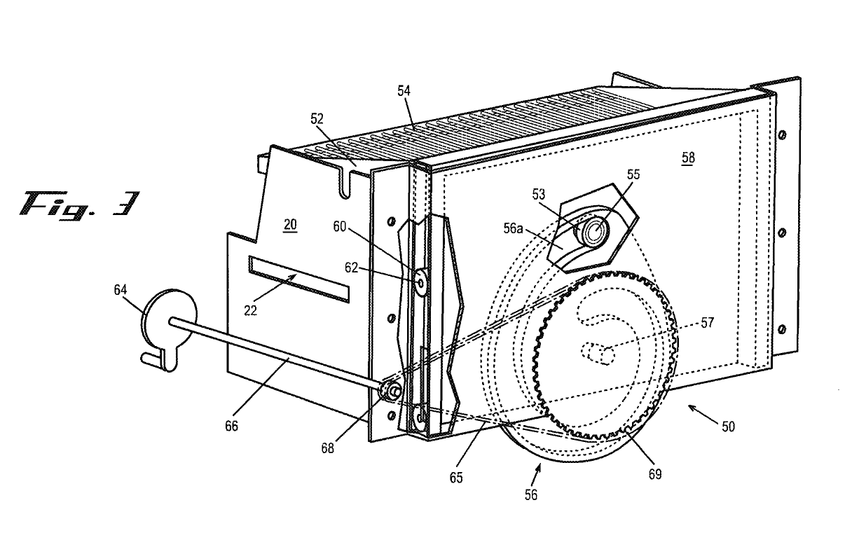

As such, referring now to FIGS. 1 and 3, the preferred embodiment also includes a mechanism or means for raising and/or lowering the cooking grate 54. In the preferred embodiment, the cooking grate 54 may be raised and lowered by activating a cam 56 to raise and/or lower the grate frame 52 upon which the cooking grate 54 rests. In this preferred implementation, the grate frame 52 may be movably engaged with the firebox assembly 20, such that the grate frame 52 may be raised and/or lowered to be further from and/or closer to the gas burners or the charcoal tray disposed in the interior of the firebox assembly 20.

In this preferred embodiment, the cam 56 contained in a cam housing 58 may be used to raise and lower the grate frame 52. The preferred cam housing 58 will be attached to the back wall 26 of the firebox assembly 20, with the cam 56 located between the cam housing 58 and the firebox assembly 20. The preferred cam 56 will be engaged with the grate frame 52 such that when the cam 56 is activated and rotates on the cam pin 57, the grate frame 52 is raised and/or lowered to place the cooking grate 54 at the desired distance from the heat.

More specifically, as best seen in FIG. 3, as the cam 56 is activated and rotates on the cam pin 57, a lift roller 53 cooperates with, and travels along, a cam track 56a defined by the cam 56. The lift roller 53 is mounted to the grate frame 52 by means of a roller axle 55, and therefore causes the grate frame 52 to be moved either up or down as the lift roller 53 is urged along the cam track 56a. Motion of the grate frame 52 within the cam housing 58 is assisted by housing rollers 60 rotatably mounted to the cam housing 58 by means of housing roller pins 62.

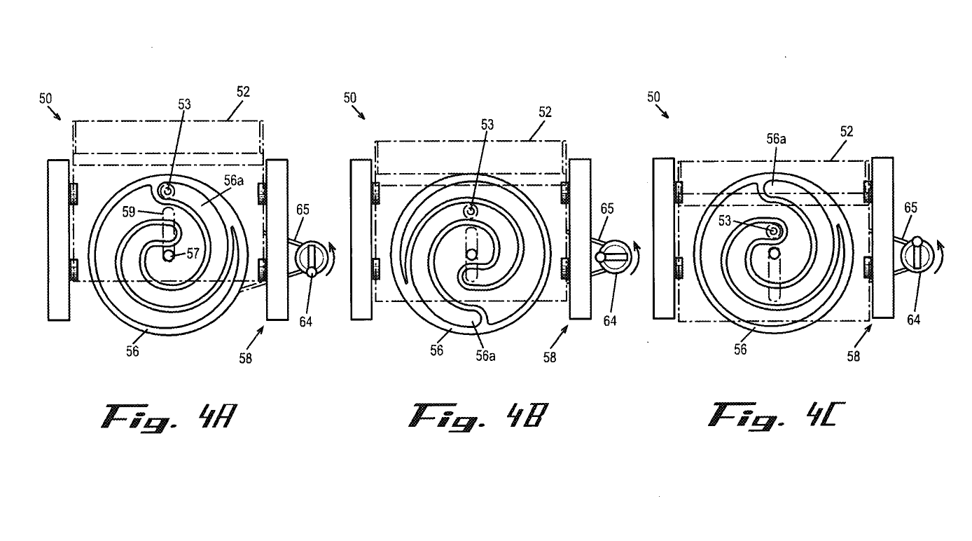

One preferred method of activating the cam 56 is a crank handle 64 located toward the front of the barbecue grill 10. In the implementation shown, the crank handle 64 is coupled to a shaft 66 at a first end of the shaft 66. The opposite end of the shaft 66 is coupled to a sprocket 68, which in turn engages a cam drive chain 65 coupled to the cam 56 by means of a cam sprocket 69. FIG. 4A shows the grate frame 52 in a raised position. To lower the grate frame 52, a user simply rotates the crank handle 64 in a counter-clockwise fashion, as indicated by the arrow. As the crank handle 64 is rotated counter-clockwise, the cam 56 will similarly rotate in a counter-clockwise fashion by means of the sprocket 68, cam drive chain 65, and cam sprocket 69 mechanism discussed above. As shown in FIG. 4B, the lift roller 53 is urged down the cam track 56a toward the center of the cam 56, thereby lowering the grate frame 52 within the cam housing 58. As shown in FIG. 4C, once the lift roller 53 has reached that portion of the cam track 56a nearest the center of the cam 56, the grate frame 52 will be in its lowest possible position within the cam housing 58.

Note that in the implementation depicted in FIG. 1, the shaft 66 is disposed through the sides of the charcoal tray housing assembly 40, connecting the crank handle 64 to the cam 56 as described above. In other embodiments and implementations, the shaft 66 may be located in other locations such as, for example, disposed through the base (passing underneath the firebox assembly 20).

Similarly, while a crank handle 64 is depicted as the control activating the cam 56, other controls may be used in other implementations, such as for example, a button engaged by the user to activate a motorized cam 56 and/or a cam 56 coupled to a motor or other electrical or mechanical device. There are multiple ways that other mechanisms or methods could be used to engage and raise/lower the grate frame 52, and such mechanisms and methods are intended to be within the scope of this disclosure and the present invention.

In some implementations of the preferred embodiment, the system may be configured such that the charcoal tray 38 and tray carrier assembly 30 are prevented from passing through the receiving slot 22 into the firebox assembly 20 until the grate frame 52 is first raised. In other implementations, no such restriction will exist, and the user will have the option of moving or sliding the tray carrier assembly 30 through the receiving slot 22 into the firebox assembly 20 regardless of the location of the grate frame 52.

Such a restriction on the tray carrier assembly 30 to prevent insertion into the firebox assembly 20 until the grate frame 52 is raised, may be accomplished in a variety of ways. For example, the sides of the grate frame 52 may be configured to block the receiving slot 22 until the grate frame 52 is raised a predetermined distance. Similarly, a lock, pin, or other element may be located on the firebox 20, the charcoal tray housing assembly 40, and/or tray carrier assembly 30 and configured such that the tray carrier assembly 30 is prevented from passing through the receiving slot 22 until the grate frame 52 is first raised a predetermined distance.

As further depicted in FIG. 1, the preferred barbecue grill 10 also includes various other components not specifically described above as would be known to one of ordinary skill in the art, including a support 12 for the firebox assembly 20, such as the illustrative base panels and/or the illustrative support elements depicted in FIG. 1. Similarly, the preferred barbecue grill 10 includes controls for items such as gas burners, an igniter, etc., illustrated for example in FIG. 1 as control knobs 14. The preferred barbecue grill 10 may also include a lid 24 for the firebox assembly 20, such as the lid 24 depicted in FIG. 1.

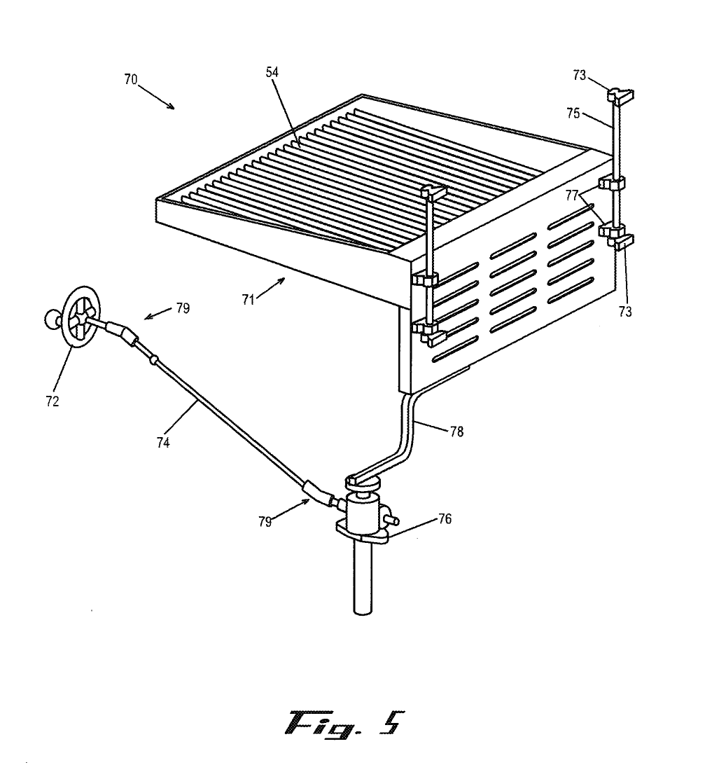

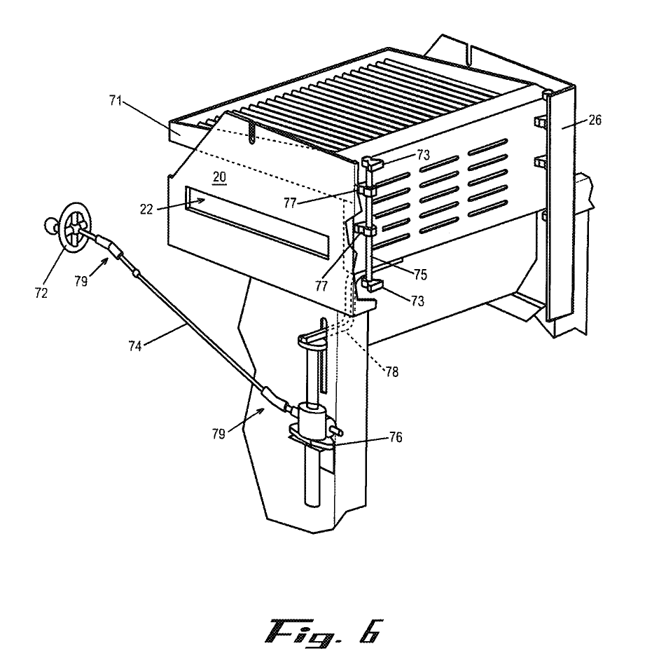

Referring now to FIGS. 5 and 6, an alternate preferred embodiment of a grate lift assembly 70 is discussed. As shown, the grate lift assembly 70 includes a cooking grate 54 supported by grate frame 71, and a jack 76 connected to the grate frame 71 by means of lift arm 78 for raising and lowering the grate frame 71. Preferably, the jack 76 is a screw-type jack that is activated by means of rotating a shaft 74 that is connected at a first end to the jack 76 and at its opposing end to a crank handle 72. Preferably, the crank handle 72 is accessible to a user at the front side of the grill 10, similar to the embodiment previously discussed in FIG. 1.

As shown in FIG. 6, the grate lift assembly 70 further includes mounting blocks 73, slide shafts 75, and slide blocks 77, for securing the grate frame 71 to the firebox assembly 20. Preferably, each slide shaft 75 is secured to the back wall 26 of the firebox assembly 20 by a pair of mounting blocks 73, one being disposed at each end of the slide shaft 75. Slide blocks 77 are configured to securely travel along each slide shaft 75, and are in turn secured to the grate frame 71. As such, the grate frame 71 is secured to the firebox assembly 20, while at the same time having a degree of freedom of movement along the slide shaft 75. To move the grate frame 71 from its lowered position (FIG. 5) to its raised position (FIG. 6), a user simply rotates the crank handle 72, thereby activating the jack 76, which motion is translated to the grate frame 71 by means of the lift arm 78. The grate frame 71 is similarly lowered by simply reversing the direction of rotation of the crank handle 72. Note, dependent upon the desired positioning of the crank handle 72 relative to the jack 76, universal joints 79 can be used as needed along the length of the shaft 74.

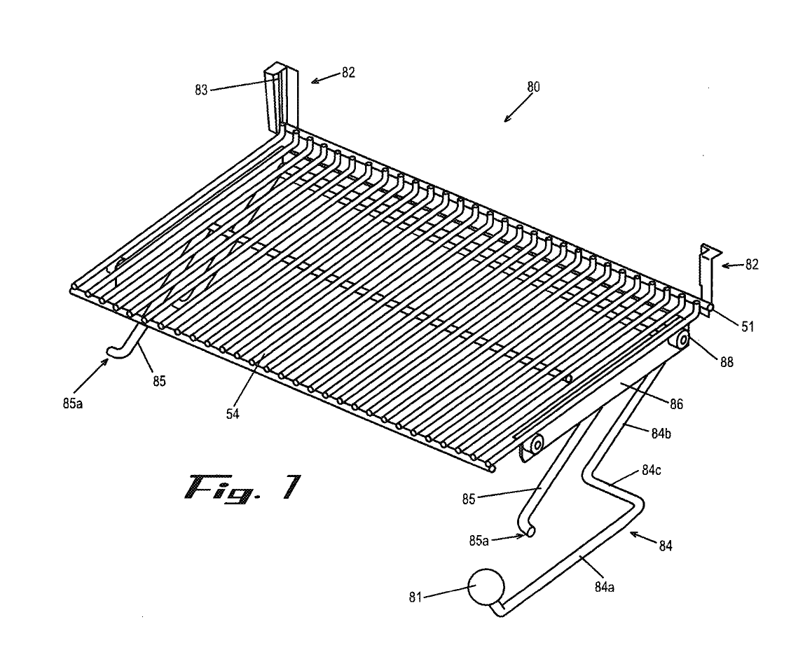

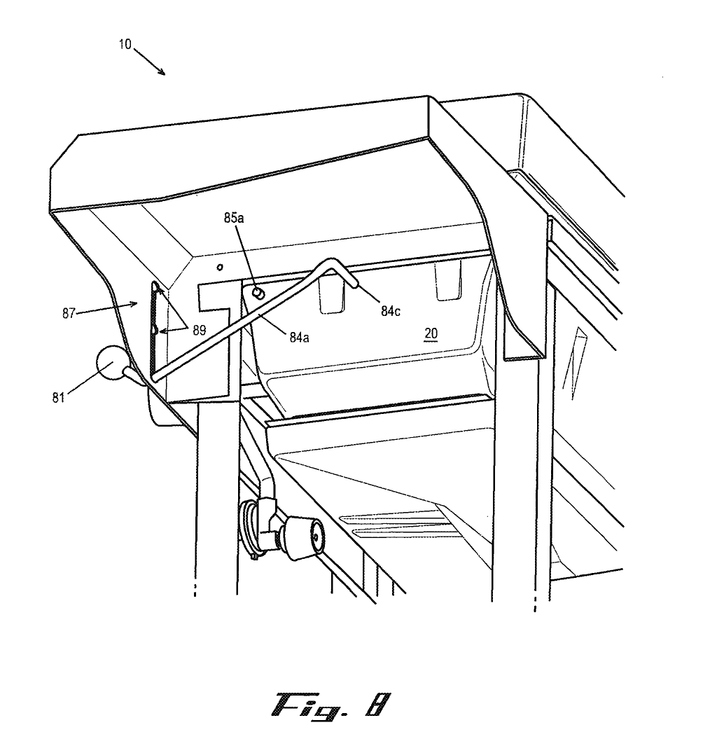

Referring now to FIGS. 7 and 8, another preferred embodiment of a grate lift assembly 80 is discussed. As shown, the grate lift assembly 80 preferably includes a substantially U-shaped support frame 86 for supporting a cooking grate 54 in a horizontal disposition as the support frame 86 and associated cooking grate 54 are raised and/or lowered by a lift wire 84 and associated plurality of pivot wires 85. The lift wire 84 includes a first portion 84a that is outside the firebox assembly 20, a second portion 84b that is inside the firebox assembly 20 and pivotally connected to the support frame 86, and a central portion 84c that penetrates the firebox assembly 20 in a manner that allows the lift wire 84 to be pivoted about the central portion 84c, as best seen in FIG. 8. Preferably, each pivot wire 85 includes a first end 85a that is pivotally mounted within an aperture in the firebox assembly 20 and a second end (not shown) that is pivotally mounted to the support frame 86. The grate lift assembly 80 further includes a pair of guide brackets 82, each guide bracket 82 including a guide slot 83 configured to provide a path of travel for a corresponding guide pin 51 disposed on the cooking grate 54. A plurality of frame rollers 88 disposed on the support frame 86 ensure that the support frame 86 is moveable relative to the cooking grate 54 with reduced friction.

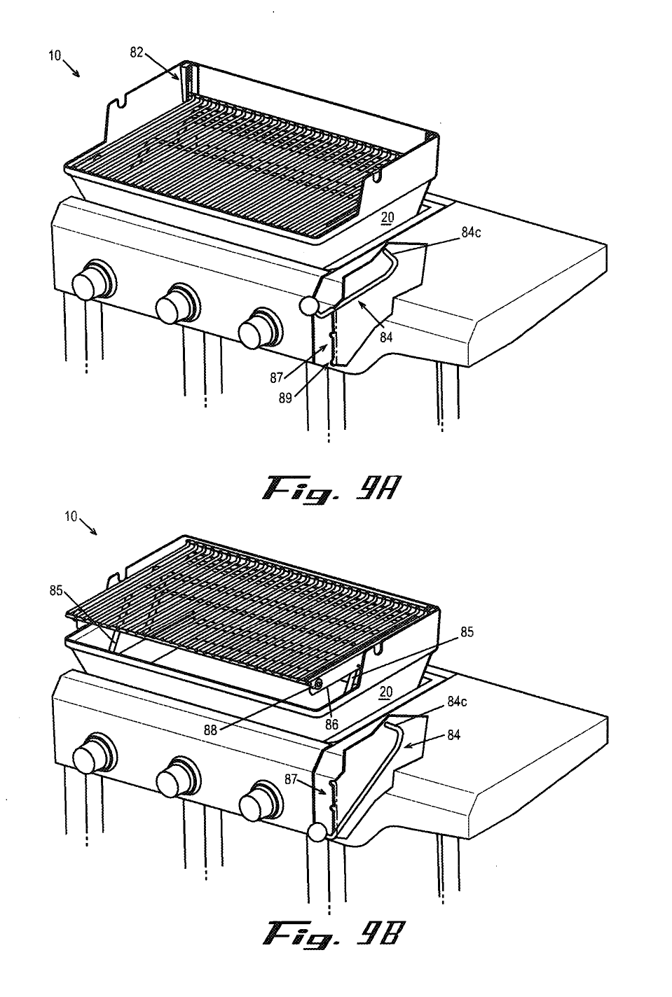

To raise the cooking grate 54 from its lowered position, as shown in FIG. 9A, to its raised position, as shown in FIG. 9B, a user simply pivots the free end of the lift wire 84 downwardly along adjustment slot 87. As shown, the free end of the lift wire 84 includes a knob 81 to assist the user in operating the grate lift assembly 80. As the free end of the lift wire 84 is rotated downwardly, the lift wire 84 pivots relative to the firebox assembly 20 about the central portion 84c of the lift wire 84 such that the second portion 84b of the lift wire 84 urges the support frame 86 upwardly. As the support frame 86 is urged upwardly, it is simultaneously urged in a forward direction due to the pivoting motion of the lift arm 84 relative to the support frame 86. As the support frame 86 is urged upwardly and forwardly, the pivot arms 85 disposed on opposing sides of the support frame 86 provide stability and help maintain the support frame 86 in a horizontal disposition as they pivot relative to the firebox assembly 20 and the support frame 86. As the support frame moves upwardly and forwardly, the cooking grate 54 is urged only upwardly since the guide pins 51 disposed on the cooking grate 52 remain in the guide slots 83, thereby preventing forward motion of the cooking grate 52. The cooking grate 52 is secured in its desired position by securing the lift wire 84 within the desired recess 89 of the adjustment slot 87.

The above preferred implementations of a removable charcoal tray system for use in a gas barbecue grill are illustrative, and other systems and methods of implementing the removable charcoal tray system are contemplated. Accordingly, it should be emphasized that the above-described embodiments of the apparatus and methods of the present invention, particularly, any “preferred” embodiments, are possible examples of implementations, merely set forth for a clear understanding of the principles of the present invention. Many variations and modifications may be made to the above-described embodiment(s) of the invention without departing substantially from the spirit and principles of the invention. All such modifications and variations are intended to be included herein within the scope of this disclosure and the present invention.

What is claimed is:

1. A gas barbecue grill comprising:
a firebox assembly containing a gas burner element, a cooking grate supported thereabove, a top casting rotatably affixed thereto, said firebox assembly defining a receiving slot in a sidewall thereof; and
a tray carrier assembly configured to be slidably received within said receiving slot of said firebox assembly, said tray carrier assembly being configured to support a charcoal tray.

2. The gas barbecue grill of claim 1, wherein said tray carrier assembly further comprises:
a front plate portion;
a back plate portion; and
a pair of carrier members, said carrier members being parallel and extending from said front plate portion to said back plate portion; and
wherein said carrier members are configured to support said charcoal tray.

3. The gas barbecue grill of claim 2, wherein each said front plate portion and said back plate portion are of substantially the same dimensions of said receiving slot such that said receiving slot can be closed by one of said front plate portion and said back plate portion.

4. The gas barbecue grill of claim 2, wherein said tray carrier assembly further comprises a handle disposed on said front plate portion.

5. The gas barbecue grill of claim 1, further comprising a charcoal tray housing assembly disposed adjacent said receiving slot and configured to slidably receive said tray carrier assembly such that said tray carrier assembly is slidable from said charcoal tray housing through said receiving slot into said firebox assembly.

6. The gas barbecue grill of claim 5, wherein said charcoal tray housing assembly further comprises a pair of substantially parallel ledge portions, said ledge portions being configured to slidably support said tray carrier assembly.

7. The gas barbecue grill of claim 1, further comprising:
a grate frame configured to support said cooking grate; and
a grate lift assembly configured to raise and lower said grate frame relative to said firebox assembly.

8. The gas barbecue grill of claim 7, wherein said grate lift assembly further comprises:
a cam including a cam track, said cam being rotatably secured to said gas barbecue grill;
a lift roller rotatably secured to said grate frame, said lift roller being configured to cooperate with said cam track; and
wherein rotation of said cam causes said lift roller to move along said cam track, thereby causing said grate frame to move relative to said firebox assembly.

9. The gas barbecue grill of claim 8, wherein said grate lift assembly further comprises:
a crank handle, a sprocket, and a shaft disposed therebetween such that rotation of said crank handle causes said sprocket to rotate;
a cam sprocket disposed on said cam; and
a cam drive chain connecting said sprocket and said cam sprocket such that rotation of said sprocket causes said cam sprocket to rotate, thereby causing said grate frame to move relative to said firebox assembly.

10. The gas barbecue grill of claim 7, wherein said grate lift assembly further comprises a jack coupled to said grate frame, said jack being configured to raise and lower said grate frame relative to said firebox assembly.

11. The gas barbecue grill of claim 10, wherein said jack further comprises a screw-type jack.

12. The gas barbecue grill of claim 10, further comprising:
a first pair of mounting blocks for securing a first slide shaft to said firebox assembly;
a second pair of mounting blocks for securing a second slide shaft to said firebox assembly; and
a first slide block and a second slide block, said first and second slide blocks being secured to said grate frame and being configured to slide along said first and said second slide shafts, respectively.

13. The gas barbecue grill of claim 12, further comprising:
a pair of said first slide blocks;
a pair of said second slide blocks; and
a lift arm connecting said jack to said grate frame.

14. A barbecue grill comprising:
a firebox assembly;
a cooking grate supported above said firebox assembly;
a top casting rotatably affixed to said firebox assembly; and
a grate lift assembly configured to raise and lower said cooking grate relative to said firebox, said grate lift assembly comprising:
a support frame adjacent said cooking grate for supporting said cooking grate;
a first pivot wire having a first end and a second end, said first end being rotatably mounted to said firebox assembly and said second end being rotatably mounted to said support frame;
a lift wire having a proximal end rotatably mounted to said support frame, a central portion, and a distal end, said lift wire being pivotally mounted to said firebox assembly; and
wherein urging said distal end downwardly causes said lift wire to pivot about said central portion, thereby causing said grate assembly to be raised relative to said firebox assembly.

15. The barbecue grill of claim 14, further comprising:
at least one guide pin disposed on said cooking grate; and
at least one guide bracket disposed on said firebox assembly, said guide bracket including a guide slot configured to slidably receive said guide pin such that said cooking grate is limited to substantially vertical displacement as said cooking grate is raised and lowered.

16. The barbecue grill of claim 15, wherein:
said at least one guide pin further includes a pair of guide pins disposed on opposing sides of said cooking grate; and
said at least one guide bracket further includes a pair of guide brackets disposed on opposing sides of said firebox assembly.

17. The barbecue grill of claim 14, further comprising:
a second pivot wire said second pivot wire having a first end rotatably mounted to said firebox assembly and a second end rotatably mounted to said support frame, said first pivot wire being disposed at a first end of said support frame and said second pivot wire being disposed at a second end of said support frame; and
a plurality of frame rollers rotatably mounted to said frame such that said frame rollers contact said cooking grate, thereby allowing said cooking grate to more readily move relative to said support frame.

18. A barbecue grill comprising:
a firebox assembly;
a cooking grate supported above said firebox assembly;
a top casting rotatably affixed to said firebox assembly; and
a grate lift assembly configured to raise and lower said cooking grate relative to said firebox, said grate lift assembly comprising:
a grate frame configured to support said cooking grate;
a cam including a cam track, said cam being rotatably secured to said gas barbecue grill;
a lift roller rotatably secured to said grate frame, said lift roller being configured to cooperate with said cam track; and
wherein rotation of said cam causes said lift roller to move along said cam track, thereby causing said grate frame to move relative to said firebox assembly.

19. The barbecue grill of claim 18, wherein said grate lift assembly further comprises:
a crank handle, a sprocket, and a shaft disposed therebetween such that rotation of said crank handle causes said sprocket to rotate;
a cam sprocket disposed on said cam; and
a cam drive chain connecting said sprocket and said cam sprocket such that rotation of said sprocket causes said cam sprocket to rotate, thereby causing said grate frame to move relative to said firebox assembly.

20. A barbecue grill comprising:
a firebox assembly;
a cooking grate supported above said firebox assembly;
a top casting rotatably affixed to said firebox assembly; and
a grate lift assembly configured to raise and lower said cooking grate relative to said firebox, said grate lift assembly comprising:
a grate frame configured to support said cooking grate; and
a jack coupled to said grate frame, said jack being configured to raise and lower said grate frame relative to said firebox assembly.

21. The barbecue grill of claim 20, wherein said jack further comprises a screw-type jack.

22. The barbecue grill of claim 20, further comprising:
a first pair of mounting blocks for securing a first slide shaft to said firebox assembly;
a second pair of mounting blocks for securing a second slide shaft to said firebox assembly; and
a first slide block and a second slide block, said first and second slide blocks being secured to said grate frame and being configured to slide along said first and said second slide shafts, respectively.

23. The barbecue grill of claim 22, further comprising:
a pair of said first slide blocks;
a pair of said second slide blocks; and
a lift arm connecting said jack to said grate frame.

24. A barbecue grill comprising:
a firebox assembly containing a gas burner element;
a cooking grate supported above said firebox assembly;
a top casting rotatably affixed to said firebox assembly; and
a grate lift assembly configured to raise and lower said cooking grate relative to said firebox, said grate lift assembly comprising:
a support frame adjacent said cooking grate for supporting said cooking grate;
a first pivot wire having a first end and a second end, said first end being rotatably mounted to said firebox assembly and said second end being rotatably mounted to said support frame;
a lift wire having a proximal end rotatably mounted to said support frame, a central portion, and a distal end, said lift wire being pivotally mounted to said firebox assembly; and
wherein urging said distal end downwardly causes said lift wire to pivot about said central portion, thereby causing said grate assembly to be raised relative to said firebox assembly.

25. The barbecue grill of claim 24, further comprising:
at least one guide pin disposed on said cooking grate; and
at least one guide bracket disposed on said firebox assembly, said guide bracket including a guide slot configured to slidably receive said guide pin such that said cooking grate is limited to substantially vertical displacement as said cooking grate is raised and lowered.

26. The barbecue grill of claim 25, wherein:
said at least one guide pin further includes a pair of guide pins disposed on opposing sides of said cooking grate; and
said at least one guide bracket further includes a pair of guide brackets disposed on opposing sides of said firebox assembly.

27. The barbecue grill of claim 24, further comprising:
a second pivot wire said second pivot wire having a first end rotatably mounted to said firebox assembly and a second end rotatably mounted to said support frame, said first pivot wire being disposed at a first end of said support frame and said second pivot wire being disposed at a second end of said support frame; and
a plurality of frame rollers rotatably mounted to said frame such that said frame rollers contact said cooking grate, thereby allowing said cooking grate to more readily move relative to said support frame.
